(19) United States
(12) Patent Application Publication
(10) Pub. No.: US 2006/0262969 A1
(43) Pub. Date: Nov. 23, 2006

(54) Image processing method and computer readable medium

(75) Inventor: Kazuhiko Matsumoto, Minato-ku (JP)

Correspondence Address: PEARNE & GORDON LLP, 1801 EAST 9TH STREET, SUITE 1200, CLEVELAND, OH, 44114-3108, US

(73) Assignee: Ziosoft, Inc., Tokyo (JP)

(21) Appl. No.: 11/368,216

(22) Filed: Feb. 22, 2006

(30) Foreign Application Priority Data
May 19, 2005 (JP) P.2005-146685

(51) Int. Cl. G06K 9/00

(52) U.S. Cl. 382/131; 382/154

(57) ABSTRACT

When conducting a medical diagnosis using image display and histogram display, an image processing method and a computer readable medium for image processing are provided which enable an appropriate histogram to be displayed in response to the intention of the user. When there is a histogram 1 corresponding to a voxel group 2 in image data 3, and when the voxel group 2 is changed to a voxel group 4, a histogram 5 corresponding to the voxel group 4 changes. Thus, the calculation objects of the histograms 1 and 5 are limited to the volume data (voxel groups 2 and 4) projected onto set three-dimensional regions and dynamic processing is performed, so that as the setting of the voxel group is changed, the histogram is also changed in real time.

This application claims foreign priority based on Japanese Patent application No. 2005-146685, filed May 19, 2005, the contents of which is incorporated herein by reference in its entirety.

### BACKGROUND OF THE INVENTION

1. Field of the Invention

This invention relates to an image processing method and a computer readable medium for image processing based on volume rendering.

2. Description of the Related Art

A revolution is brought about in the medical field with the advent of CT (Computed Tomography) and MRI (Magnetic Resonance Imaging) making it possible to directly observe an internal structure of a human body, by the progress in the image processing technology using a computer. Medical diagnosis using tomographic images of a living body is widely conducted. Further, in recent years, as a technology for visualizing a complicated three-dimensional structure of the inside of a human body which is hard to understand simply from the tomographic images of the human body, for example, volume rendering has been used for medical diagnosis. In volume rendering, an image of the three-dimensional structure is directly rendered from three-dimensional digital data of an object provided by CT.

When handling image data provided by a CT apparatus, ROI (region of interest) is set for an observation object. ROI which represents a two-dimensional region is usually used to specify a portion of clinically interest. ROI is set as a square-shaped, a circle-shaped, or an arbitrarily-shaped region on a CT image or a nuclear medical image. When ROI is set, a histogram distribution, an average value, a standard deviation, an area, etc. of densities (pixel values) of pixels in the ROI are obtained by a computing unit, and are displayed together with a CT image. A doctor conducts a diagnosis while viewing the images.

FIG. 18 shows an example of a histogram used in a three-dimensional medical image. The histogram of a three-dimensional medical image is generated by counting a number of voxels for each voxel value (CT value, etc.,). Since the voxel value is dependent on each tissue, the histogram represents a composition of a matter. Thus, from the histogram, existence of a specific tissue can be checked, and the volume and the volume ratio of the specific tissue can be calculated.

FIG. 19 is a flowchart for calculating a histogram in an image processing method in a related art. In the image processing method in the related art, first, a frequency freq, which is an array within a possible range of voxel values from Vmin to Vmax, is allocated as a histogram in a memory (step S101).

Next, the frequency freq [Vmin to Vmax] is initialized to 0 (step S102), and an array size of volume data Vol (x,y,z), which is defined by x_max, y_max, z_max, each related to index x, y, z, is acquired (step S103).

Next, iterators i, j, k of the x, y, z indexes of the array Vol (x,y,z) are allocated (step S104). As a start of a triple loop for scanning the volume, k=0 is set (step S105), and whether or not k<z_max is determined (step S106).

If k<z_max (Yes at step S106), j=0 is set (step S107), and whether or not j<y_max is determined (step S108). If j<y_max (Yes at step S108), i=0 is set (step S109), and whether or not i<x_max is determined (step S110).

If i<x_max (Yes at step S110), the voxel value at current position in the volume data is acquired according to vox=Vol(i,j,k) (step S111). Next, count of the histogram value corresponding to the voxel value is incremented by one according to freq (vox)=freq (vox)+1 (step S112).

Then, i=i+1 is calculated (step S113), and the process returns to step S110. At step S110, if i<x_max is false (No), j=j+1 is calculated (step S114), and the process returns to step S108. At step S108, if j<y_max is false (No), k=k+1 is calculated (step S115), and the process returns to step S106. At step S106, if k<z_max is false (No), the process is terminated (step S116).

There is an art in which a histogram of the image data of a two-dimensional image is calculated, and further, a user operates the histogram in the two-dimensional image so as to change the image data (For example, refer to Adobe Systems Incorporate, PhotoShop Elements 2.0 Manual).

On the other hand, as a relevant art for a 3D (three-dimensional) image, there is an art in which an ROI is set on the 3D image, a statistical amount of the voxel values in the ROI is obtained, and a histogram is displayed (For example, JP-A-10-21362). Moreover, there is an art in which a color LUT (Look-Up Table) function is set based on the histogram of the whole volume data (For example, refer to U.S. Pat. No. 6,658,080).

However, in the image processing methods in the related arts mentioned above, the voxel group of which histogram is calculated is generally fixed, such as for example, whole of an image data which is displayed, or voxels in the ROI set on a 3D image. Thus, when a doctor, etc., changes a display angle or a magnifying scale power, the histogram does not change, and the doctor, etc., may be unable to obtain necessary information.

### SUMMARY OF THE INVENTION

It is an object of the invention to provide an image processing method and a computer readable medium for image processing which enable an appropriate histogram to be displayed in response to the intention of the user, when conducting a medical diagnosis based on image display and histogram display.

An image processing method of a first aspect of the present invention is an image processing method based on volume rendering, the image processing method comprising: generating a two-dimensional image by the volume rendering using first volume data; setting a two-dimensional area in the two-dimensional image; determining a first voxel group which is included in the first volume data, the first voxel group corresponding to the two-dimensional area being set; and generating a first histogram of the first voxel group to be dynamically changed by the two-dimensional area being set.

According to the image processing method of the invention, for example, if a user changes a display image, the histogram is recalculated each time the setting of the two-dimensional region is changed. Thus, when conducting a medical diagnosis using image display and histogram display, an appropriate histogram can be displayed in response to the intention of the user.

An image processing method of a second aspect of the present invention is an image processing method based on volume rendering, the image processing method comprising: generating a two-dimensional image by the volume rendering using first volume data; setting a two-dimensional area in the two-dimensional image; determining a first three-dimensional region represented by the first volume data, the first three-dimensional region corresponding to the two-dimensional area being set; determining a voxel group which is included in second volume data, the voxel group corresponding to the first three-dimensional region; and generating a histogram of the voxel group to be dynamically changed by the two-dimensional area being set.

The image processing method of the first aspect of the invention further comprises: determining a first three-dimensional region represented by the first volume data, the first three-dimensional region corresponding to the two-dimensional area being set; determining a second voxel group which is included in second volume data, the second voxel group corresponding to the first three-dimensional region; and generating a second histogram of the second voxel group to be dynamically changed by the two-dimensional area being set.

In the image processing method of the invention, the first voxel group is further included in a three-dimensional mask region. In the image processing method of the invention, the first histogram is generated by multiplying a weight factor corresponding to opacity of each voxel in the first voxel group. In the image processing method of the invention, a plurality of the first histograms are generated based on a plurality of the first voxel groups respectively.

In the image processing method of the invention, the volume rendering is performed based on a parallel projection. In the image processing method of the invention, the volume rendering is performed based on a perspective projection. In the image processing method of the invention, the volume rendering is performed based on a cylindrical projection.

A computer readable medium of the present invention is a computer readable medium having a program including instructions for permitting a computer to perform image processing based on volume rendering, the instructions comprising: generating a two-dimensional image by the volume rendering using volume data; setting a two-dimensional area in the two-dimensional image; determining a voxel group which is included in the volume data, the voxel group corresponding to the two-dimensional area being set; and generating a histogram of the voxel group to be dynamically changed by the two-dimensional area being set.

### BRIEF DESCRIPTION OF THE DRAWINGS

FIG. 1 schematically shows a computed tomography (CT) apparatus used in an image processing method according to an embodiment of the invention.

FIGS. 2A to 2D are explanatory diagrams for displaying a histogram dynamically in the image processing method according to an embodiment of the invention.

FIGS. 3A to 3D shows a case in which a histogram of a rendering region is displayed in the image processing method according to a first embodiment of the invention.

FIGS. 4A to 4D show a case in which a histogram of a mask region is displayed in the image processing method according to a second embodiment of the invention.

FIGS. 5A to 5D show a case in which a histogram of an opacity region is displayed in the image processing method according to a third embodiment of the invention.

FIGS. 6A to 6D show an example of presenting information of an object hidden behind in an image in the image processing method according to an embodiment of the invention.

FIG. 7 shows an example of calculating a histogram only at the points through which virtual rays pass in a case of parallel projection in the image processing method according to an embodiment of the invention.

FIG. 8 is an explanatory diagram showing a method of determining whether or not a certain voxel is included in a voxel group for calculating a histogram in the image processing method according to an embodiment of the invention.

FIG. 9 is an explanatory diagram showing a case in which a function for determining a three-dimensional region based on a two-dimensional region is generated in the image processing method according to an embodiment of the invention.

FIGS. 10A and 10B are explanatory diagrams showing that an image to be displayed and a two-dimensional region do not necessarily match.

FIG. 11 is an explanatory diagram showing a method of determining whether or not a certain voxel is included in the voxel group for calculating a histogram when an image is generated by a perspective projection method.

FIG. 12 is a flowchart of an outline of processing obtaining a histogram based on a virtual ray.

FIG. 13 is a flowchart showing details of the processing obtaining a histogram based on a virtual ray.

FIG. 14 is a flowchart showing details of the processing obtaining a histogram based on a virtual ray, further considering a mask region and opacity of an opacity function.

FIG. 15 is a flowchart showing an outline of processing obtaining a histogram by executing a region projection.

FIG. 16 is a flowchart showing a loop for obtaining a histogram in the processing obtaining a histogram by executing a region projection.

FIG. 17 is a flowchart showing a loop for obtaining a histogram in the processing obtaining a histogram by executing a region projection, further considering a mask region and opacity of an opacity function.

FIG. 18 shows an example of a histogram used in a three-dimensional medical image.

FIG. 19 is a flowchart for calculating a histogram in an image processing method in a related art.

### DESCRIPTION OF THE PREFERRED EMBODIMENTS

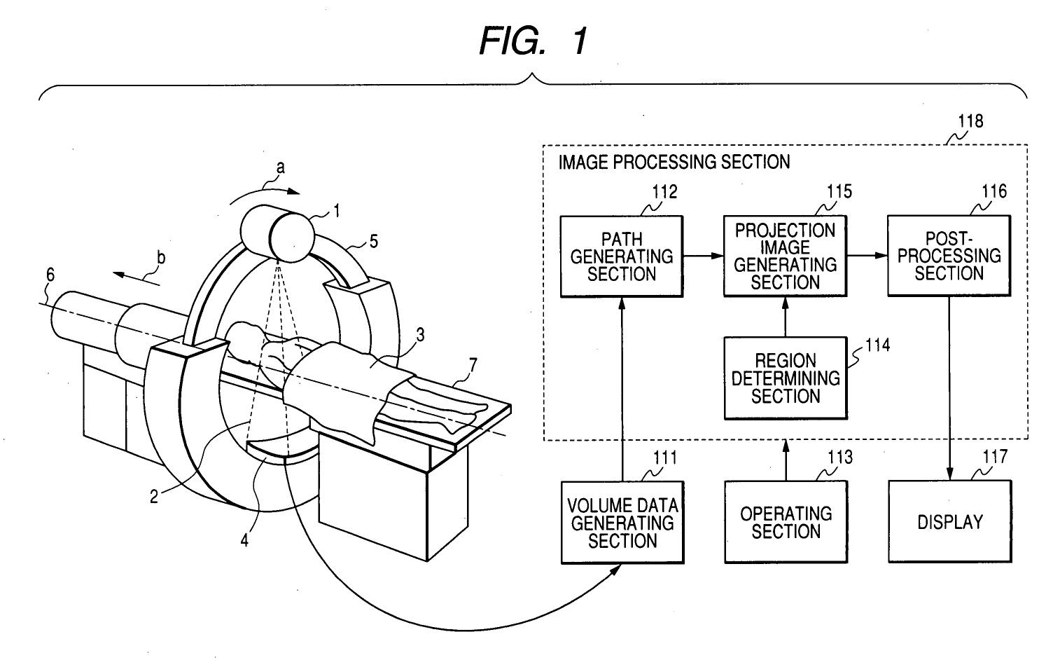

FIG. 1 schematically shows a computed tomography (CT) apparatus used in an image processing method according to an embodiment of the invention. The computed tomography apparatus is used for visualizing tissues, etc., of a subject. A pyramid-like X-ray beam 2 having edge beams which is represented by chain lines in FIG. 1 is emitted from an X-ray source 1. The X-ray beam 2 is applied on an X-ray detector 4 after transmitting through the subject, for example, a patient 3. In this embodiment, the X-ray source 1 and the X-ray detector 4 are disposed in a ring-like gantry 5 so as to face each other. The ring-like gantry 5 is supported by a retainer not shown in FIG. 1 so as to be rotatable (see the arrow “a”) about a system axis 6 which passes through the center point of the gantry.

In this embodiment, the patient 3 is lying on a table 7 through which the X-rays are transmitted. The table 7 is supported by a retainer which is not shown in FIG. 1 so as to be movable (see the arrow “b”) along the system axis 6.

Thus a measuring system is configured so that the X-ray source 1 and the X-ray detector 4 are rotatable about the system axis 6 and movable along the system axis 6 relatively to the patient 3. Accordingly, X-rays can be cast on the patient 3 at various projection angles and in various positions with respect to the system axis 6. An output signal from the X-ray detector 4 when the X-rays are cast on the patient 3 are supplied to a volume data generating section 11 and converted into a volume data.

In sequence scanning, the patient 3 is scanned in accordance with each sectional layer of the patient 3. When the patient 3 is scanned, while the X-ray source 1 and the X-ray detector 4 rotate around the patient 3 about the system axis 6 as its center, the measuring system including the X-ray source 1 and the X-ray detector 4 captures a large number of projections to scan each two-dimensional sectional layer of the patient 3. A tomogram displaying the scanned sectional layer is reconstructed from the measured values acquired at that time. While the sectional layers are scanned continuously, the patient 3 is moved along the system axis 6 every time the scanning of one sectional layer is completed. This process is repeated until all sectional layers of interest are captured.

On the other hand, during spiral scanning, the table 7 moves along the direction of the arrow “b” continuously while the measuring system including the X-ray source 1 and the X-ray detector 4 rotates about the system axis 6. That is, the measuring system including the X-ray source 1 and the X-ray detector 4 moves on a spiral track continuously and relatively to the patient 3 until the region of interest of the patient 3 is captured completely. In this embodiment, signals of a large number of successive sectional layers in a diagnosing area of the patient 3 are supplied to a volume data generating section 111 by the computed tomography apparatus shown in FIG. 1.

A set of volume data generated by the volume data generating section 111 is led to a path generating section 112 in an image processing section 118. The path generating section 112 generates, for example, a path determining the center line of a tissue of an observation object, and sets the generated path as a path for diagnosis. The path generated by the path generating section 112 is supplied to a projection image generating section 115.

On the other hand, a region determining section 114 in the image processing section 118 sets a three-dimensional region of which histogram is generated, and supplies the three-dimensional region to the projection image generating section 115. The three-dimensional region of which histogram is generated can be changed interactively by an instruction from an operating section 113 that is described later.

The projection image generating section 115 emits a virtual ray in accordance with the data supplied from the region determining section 114 while moving a virtual viewpoint along the path supplied from the path generating section 112, and generates a projection image of the tissue of the observation three-dimensional region. The projection image generated in the projection image generating section 115 is supplied to a post-processing section 116. The post-processing section 116 performs processing such as a composite display of the projection image and the histogram, a display of a plurality of projection images in parallel, an animation display of sequentially displaying a plurality of projection images, a simultaneous display with a virtual endoscope (VE) image. The projection image processed in the post-processing section 116 is supplied to a display 117 and is displayed.

The operating section 113 generates a control signal for changing the three-dimensional region of which histogram is generated, switching the projection image, etc., in response to an operation signal from a keyboard, a mouse, etc., and supplies the control signal to the image processing section 118. Accordingly, a user (doctor) can change the projection image interactively while viewing the projection image displayed on the display 117, and can observe a diseased part in detail.

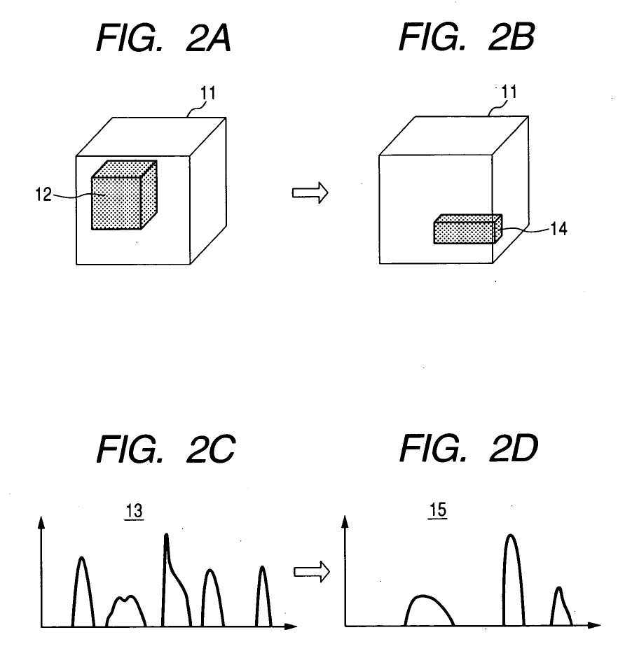

FIGS. 2A to 2D are explanatory diagrams for displaying a histogram dynamically in the image processing method according to an embodiment of the invention. The image processing method according to the embodiment is an image processing method based on volume rendering, wherein a three-dimensional region is set in an image generated by the rendering of volume data (image data) 11, and a histogram of the volume data projected onto the set three-dimensional region is generated. For example, when the volume data is projected onto the set three-dimensional region, and the region contains a voxel group 12 as shown in FIG. 2A, a histogram 13 corresponding to the voxel group 12 is the histogram as shown in FIG. 2C. When the setting of the three-dimensional region is changed and the volume data projected onto the set three-dimensional region is a voxel group 14 as shown in FIG. 2B, a histogram 15 corresponding to the voxel group 14 is dynamically generated as shown in FIG. 2D.

Thus, in the image processing method of the embodiment, the calculation objects of the histograms 13 and 15 are limited to a part of the volume data (voxel groups 12 and 14) projected onto the set three-dimensional regions and dynamic processing is performed, so that as the setting of the three-dimensional region is changed, the histogram is also changed in real time. Accordingly, when a user such a doctor changes display of a three-dimensional region, a histogram is dynamically generated and is displayed, so that an appropriate histogram responsive to the intention of the user can be displayed and the user can conduct a diagnosis efficiently.

Next, in embodiments of the image processing method of the invention, a specifying method of the three-dimensional region for calculating a histogram will be discussed, such as (1) rendering region, (2) mask region, (3) opacity region, or a combination thereof.

### First Embodiment

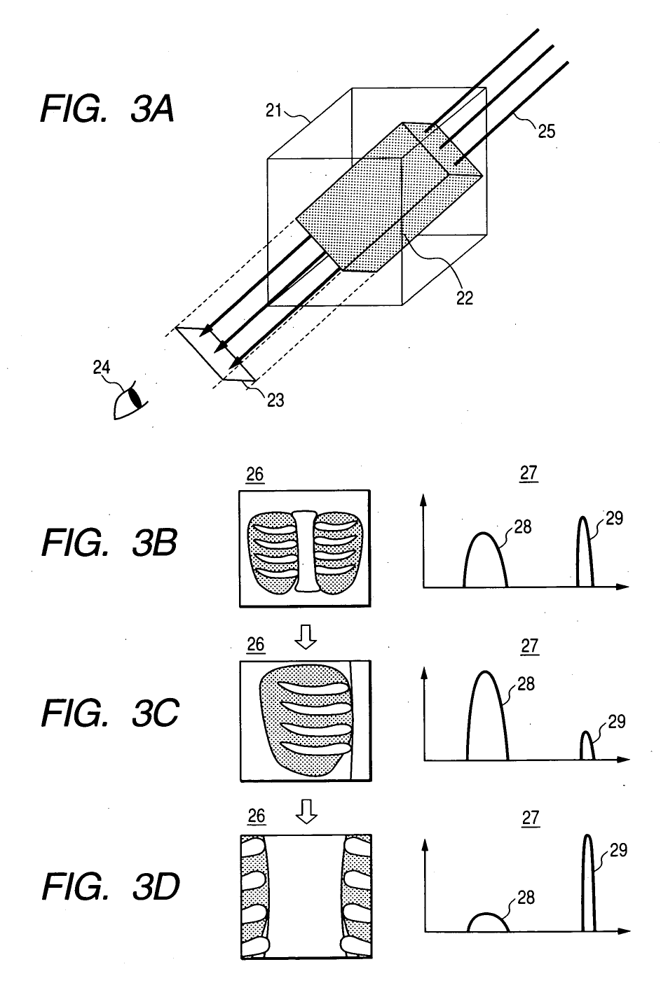

FIGS. 3A to 3D show a case in which a histogram of a rendering region is displayed in the image processing method according to a first embodiment. As shown in FIG. 3A, a rendering region 22 is a region in three-dimensional image data 21, the region being projected onto a two-dimensional screen 23 set in an image generated by rendering. That is, the three-dimensional region provided by cutting out the three-dimensional image data 21 by virtual rays 25 is the rendering region 22. In this case, the rendering region 22 is changed by changing a viewpoint 24, size (magnifying scale power) of the two-dimensional screen 23, etc. (changing the setting of a two-dimensional area, which is the area of the image generated by rendering).

FIGS. 3B, 3C, and 3D show image display and histograms corresponding thereto when the magnifying scale power is changed. As shown in the figures, as the magnifying scale power of a two-dimensional screen 26 is changed, a histogram 27 representing fat 28 and bones 29 is dynamically generated and is displayed. Accordingly, the user such as a doctor simply specifies the two-dimensional screen 26 to be displayed, as a two-dimensional area, and the histogram 27 corresponding to the two-dimensional screen 26 is dynamically generated and is displayed. Thus, the user can see the appropriate histogram responsive to the intention of the user and can conduct a diagnosis smoothly.

### Second Embodiment

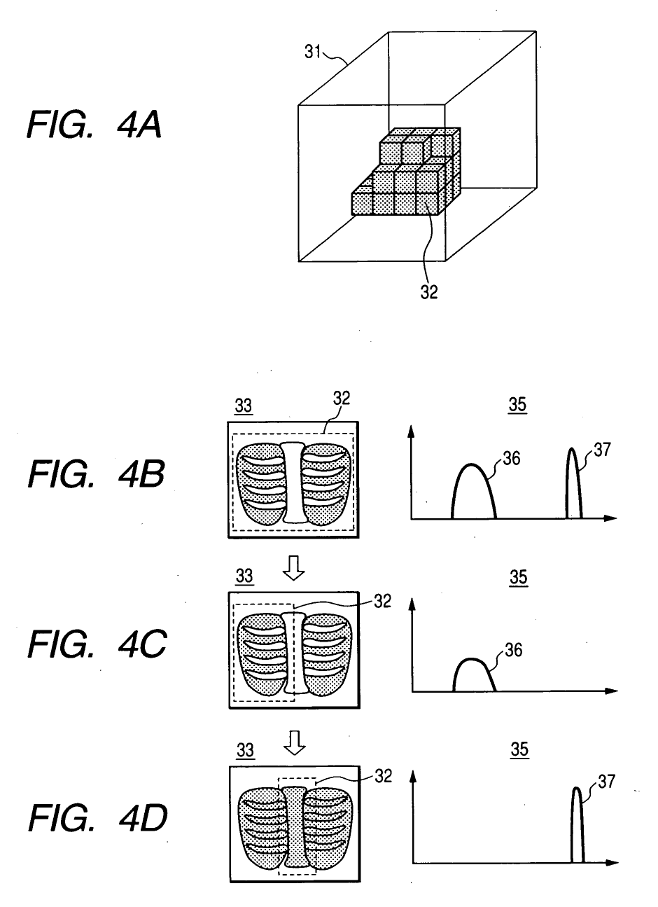

FIGS. 4A to 4D show a case in which a histogram of a mask region is displayed in the image processing method according to a second embodiment. As shown in FIG. 4A, a mask region 32 is a three-dimensional region specified by a three-dimensional mask, in three-dimensional image data 31. When the mask region 32 is changed by performing various operations, a histogram is dynamically generated accordingly.

FIGS. 4B, 4C, and 4D show image display and histograms corresponding thereto when the mask region 32 is changed. As shown in the figures, as the mask region 32 is changed, a histogram 35 representing fat 36 and bones 37 changes. Accordingly, the user such as a doctor simply specifies the mask region 32, whereby the histogram 35 corresponding to the mask region 32 is displayed. Thus, the user such as a doctor can conduct a diagnosis smoothly without specifying the three-dimensional region for calculating the histogram.

### Third Embodiment

In volume rendering, color value and opacity are acquired from voxel values using LUT (Look-Up Table) functions, and the color value and the opacity are used for rendering. Particularly, a function for calculating the opacity among the LUT (Look-Up Table) functions is called an opacity function.

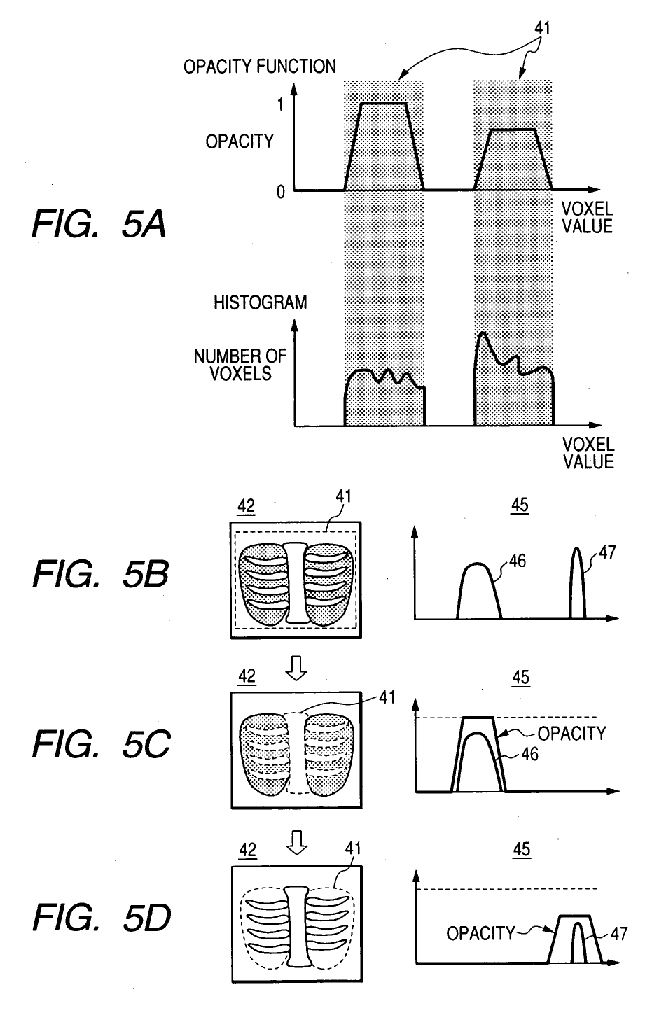

FIGS. 5A to 5D show a case in which a histogram responsive to the opacity calculated using the opacity function from the voxel values is displayed in the image processing method according to a third embodiment. As shown in FIG. 5A, an opacity region 41 is a three-dimensional region where the opacity is not zero (visible region) on the opacity function. The opacity changes as the opacity function is changed. A contribution degree of each voxel value to the histogram may be obtained by multiplying a weight factor according to the opacity.

FIGS. 5B, 5C and 5D show image display and histograms corresponding thereto when the opacity region 41 on the opacity function is changed. As shown in the figures, as the opacity region 41 on the opacity function is changed, a histogram 45 representing fat 46 and bones 47 changes. Accordingly, the user such as a doctor simply specifies the opacity region 41 on the opacity function, whereby the histogram 45 corresponding to the opacity region 41 on the opacity function is dynamically generated and is displayed. Thus, the user can view the appropriate histogram responsive to the intention of the user, and can conduct a diagnosis smoothly.

### EXAMPLE 1

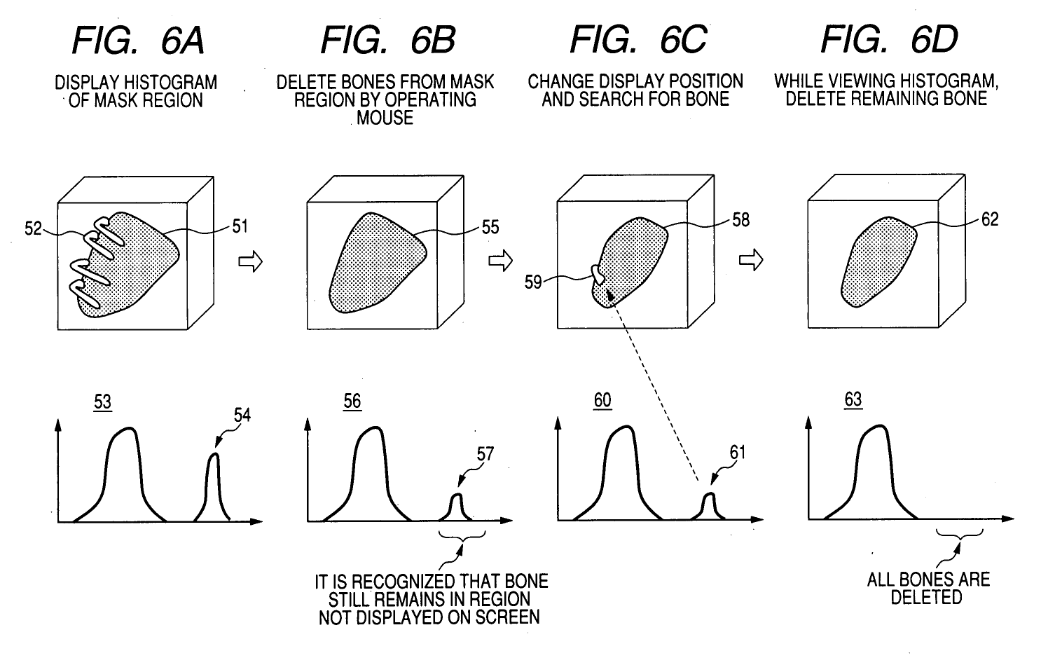

FIGS. 6A to 6D show an example of presenting information of an object hidden behind in an image in the image processing method according to an embodiment. In FIG. 6A, bones 52 are displayed in a mask region 51, and a histogram 53 of the mask region 51 indicates that a bone 54 exists in the mask region 51. In FIG. 6B, the user deletes the bones from the mask region 55 by operating a mouse on the screen, but it is recognized by a histogram 56 of the mask region 55 that a bone 57 still remains in a mask region not displayed on the screen.

Then, as shown in FIG. 6C, the user changes a display position on the screen and a mask region 58, and searches for a bone 59. While viewing a histogram 60, the user deletes a remaining bone 61. Then, the user checks that all bones are deleted according to a histogram 63 shown in FIG. 6D.

Thus, according to the image processing method of the embodiment, when deleting bones, etc., to observe a tissue, the user simply specifies a mask region, whereby a histogram corresponding to the mask region is dynamically generated and is displayed. Thus, information of an object hidden from the user's view can be easily acquired in real time.

Moreover, when the user clicks on a histogram displayed on a screen of a CRT, etc., by a mouse, voxel in the volume data having a voxel value equal to the voxel value representing the clicked part can be selected, since at least one such voxel exists in the three-dimensional region from which the histogram is calculated. In this case, the user can also click on an axis of the histogram for acquiring the voxel value, so that voxel in the volume data having a voxel value equal to the acquired voxel value can be selected. One voxel maybe selected by a program from the selected voxels having the voxel value, or all of the selected voxels having the voxel value may be selected. Alternatively, the voxels having the voxel value may be clustered as voxel groups, and among them, the voxel group having the maximum volume may be selected. An image may be changed so that the selected voxel is immediately displayed on the screen. The selected voxel may also be deleted from the volume data, or may be adopted as a mask region. Furthermore, a plurality of voxel values may also be selected on a histogram at the same time. Accordingly, a region of interest of the user can be easily pointed out through voxel value.

Moreover, the volume data may have time-series information. In this case, the histogram can be dynamically changed as an animation of the image is performed.

A plurality of volume data of which coordinates are associated with each other may exist. When such plurality of volume data is provided, an image may be generated by volume rendering using one of the plurality of volume data, or an image may be generated by volume rendering while combining the plurality of volume data. Then, a histogram may be generated from selected one of the plurality of volume data, or a plurality of histograms may be generated. A histogram does not necessarily correspond to a volume data used for rendering a displayed image. For example, when a first voxel data is used for display and a second voxel data is not, a histogram of a voxel group in the second volume data can be generated, such that the voxel group corresponds to a voxel group in the first volume data which is to be used if a histogram of the first volume data is to be generated. This is effective, for example, in a case in which volume data is acquired from both a PET apparatus and a CT apparatus, the coordinates of the volume data are associated with each other, and the volume data of one or both of the apparatuses are combined for display.

Moreover, in the image processing method of the embodiment, when a projection of virtual rays is interrupted, a histogram of the region up to the interrupt position can be obtained. Particularly, in a ray casting method, processing of attenuating a light amount is performed as the virtual rays pass through voxels, and a histogram up to the position where the light amount becomes zero can be displayed. Accordingly, when a semitransparent region is displayed, a dim object behind the semitransparent region can be displayed on a histogram, while a portion behind the opacity region is not displayed on the histogram.

Moreover, the image processing method of the embodiment may also be applied to MIP (Maximum Intensity Projection) which is a method of acquiring a voxel having a maximum value on a projected virtual ray and performing image processing. In the MIP method, a histogram of the region through which the virtual rays pass may also be obtained, or a histogram of the maximum value may be obtained. MIP processing can be executed by a relatively simple calculation in the volume rendering, and methods of acquiring a minimum value, an average value, and an accumulation value are available as similar processing. Particularly, the method of acquiring the minimum value is called MinIP (Minimum Intensity Projection). Further, the image processing method of the embodiment may also be applied to MIP with thickness which performs MIP processing after cutting out a cross section such as MPR (Multi Planar Reconstruction), with some thickness. The image processing method of the embodiment may also be applied to MinIP with thickness In short, the image processing method of the embodiment can be applied to any volume rendering method using volume data.

### EXAMPLE 2

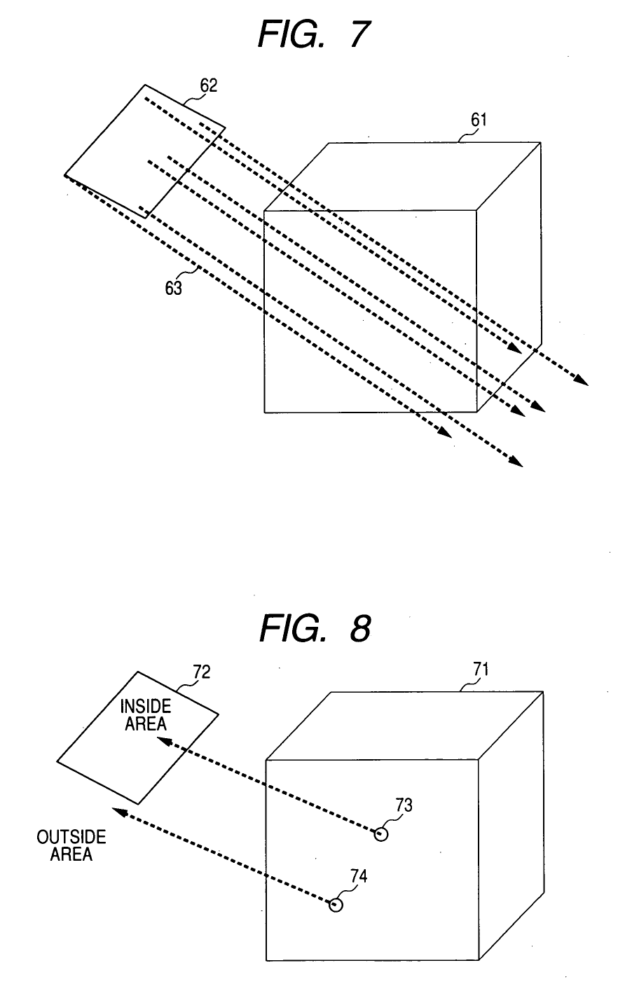

FIG. 7 shows an example of calculating a histogram only at the points through which virtual rays pass in a case of parallel projection in the image processing method according to an embodiment. As shown in the figure, a two-dimensional area 62 corresponds to a three-dimensional region where virtual rays 63 pass through volume data 61 in parallel, and voxel data in the three-dimensional region is projected onto the two-dimensional area 62. At this time, in the example, a histogram is calculated only at the points through which virtual rays 63 pass, in the volume data 61.

According to the example, the histogram can be calculated at the same time as the virtual rays 63 are projected when the rendering is performed. Thus, it is easy to calculate the histogram. The user simply specifies the direction of the virtual rays 63, whereby the histogram corresponding to the three-dimensional region through which the virtual rays 63 pass (two-dimensional area) is dynamically generated and is displayed. Thus, the user such as a doctor need not specify the three-dimensional region for calculating the histogram, and can conduct a diagnosis smoothly while viewing the appropriate histogram responsive to the intention of the user. In this case, in the calculation step when virtual rays 63 are sparse, an error is involved, and thus preferably the projection interval is set to such an extent that an error is not caused to occur.

FIG. 8 shows a method of determining whether or not a certain voxel is to be included in a voxel group for calculating a histogram in the image processing method according to an embodiment. As shown in the figure, whether or not each of voxels 73 and 74 in volume data 71 is included in the voxel group for calculating a histogram is determined by whether the voxel can be projected onto a two-dimensional area 72. That is, the voxel 73 is projected onto the two-dimensional area 72, and thus is the voxel group for calculating a histogram. The voxel 74 is projected outside the two-dimensional area 72, and thus is not included in the voxel group for calculating a histogram. Accordingly, whether or not each voxel is included in the voxel group for calculating a histogram can be determined directly.

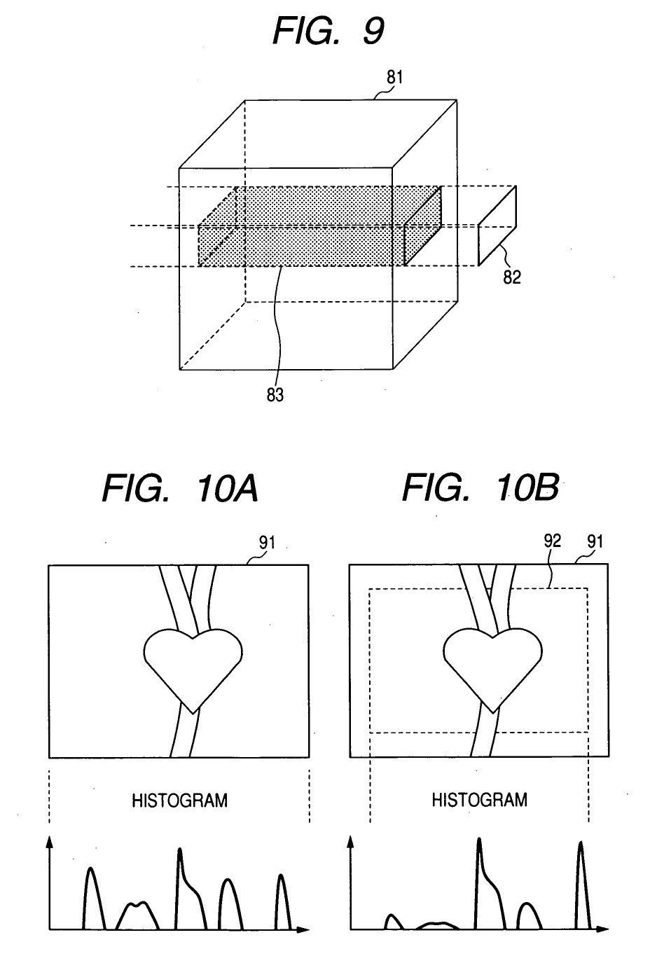

FIG. 9 shows a case in which a function for determining a three-dimensional region based on a two-dimensional area is generated in the image processing method according to an embodiment. In this case, a function of determining a three-dimensional region 83 in volume data 81 based on a two-dimensional area 82 is generated. The function is dynamically changed as the viewpoint, etc., is changed, so that whether or not each voxel is included in a voxel group for calculating a histogram is easily determined. According to the function, when the two-dimensional area 82 is a rectangle, lines including the four sides of the rectangle are projected onto a three-dimensional region respectively, and four planes are generated. Thus, the region 83 in the volume data 81 is the region of which boundaries are marked by the four planes, and the calculation can be executed easily. The function can be used to limit a scanning range of the volume data 81 when calculating a histogram.

FIGS. 10A and 10B show that an image to be displayed and a two-dimensional area for calculating a histogram do not necessarily match. FIG. 10A shows a case in which an image 91 to be displayed matches with a two-dimensional area for calculating a histogram (the case in which the whole display screen is set as a two-dimensional area). FIG. 10B shows a case in which the image 91 to be displayed does not match with a two-dimensional area 92 for calculating a histogram (the case in which a part of the display screen is set as a two-dimensional area). As shown in the figures, the histogram of the voxels, in volume data, projected onto the set two-dimensional area 92 is calculated, so that the histogram can be changed in response to a line of sight direction (the direction of virtual rays), and a smooth diagnosis can be conducted.

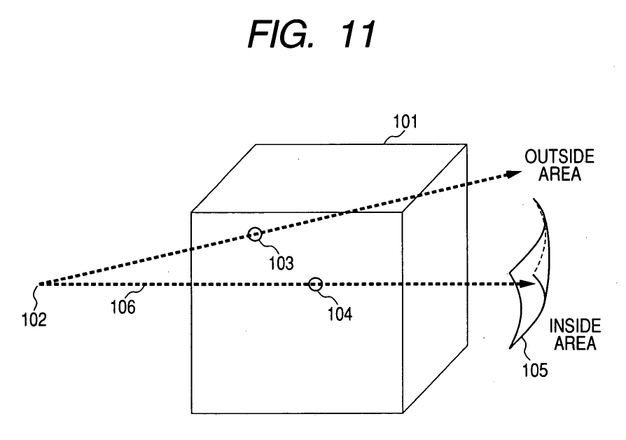

FIG. 11 shows a method of determining whether or not a certain voxel is included in a voxel group for calculating a histogram when an image is generated by a perspective projection method. As shown in the figure, in the perspective projection method, virtual rays 106 are emitted from a viewpoint 102 radially.

Whether or not each of voxels 103 and 104 in volume data 101 is included in a voxel group for calculating a histogram is determined by whether each of the voxels can be projected onto a two-dimensional area 105. That is, the voxel 104 is projected onto the two-dimensional area 105, and thus is the voxel group for calculating a histogram. The voxel 103 is projected outside the two-dimensional area 105, and thus is not the voxel group for calculating a histogram. Accordingly, whether or not each voxel is included in a voxel group for calculating a histogram can be determined directly. A similar determination can be also performed in a case of cylindrical projection method.

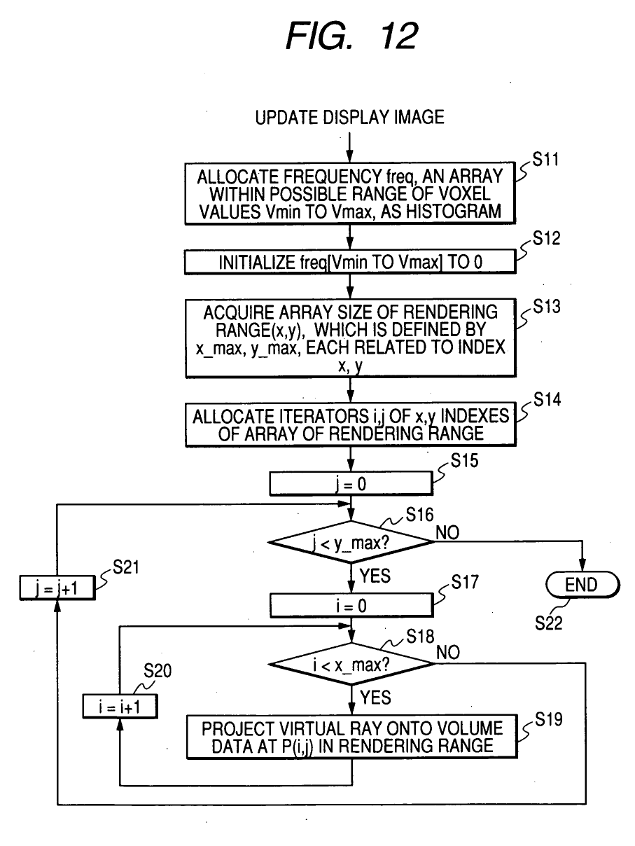

FIG. 12 is a flowchart of an outline of processing obtaining a histogram based on a virtual ray. In this case, when the display image is updated by an operation of the user such as a doctor, a frequency freq, which is an array within a possible range of voxel values from Vmin to Vmax, is allocated as a histogram in a memory (step S11).

Next, the frequency freq[Vmin to Vmax] is initialized to 0 (step S12), and an array size of rendering range (x, y), which is defined by x_max, y_max, each related to index x, y, is acquired (step S13). Next, iterators i, j of the x, y indexes of the array of the rendering range are allocated (step S14). As a start of a double loop for scanning the image, j=0 is set (step S15).

Next, whether or not j<y_max is determined (step S16). If j<y_max (Yes at step S16), i=0 is set (step S17), and whether or not i<x_max is determined (step S18). If i<x_max (Yes at step S18), a virtual ray is projected onto the volume data at P(i,j) in the rendering range (step S19).

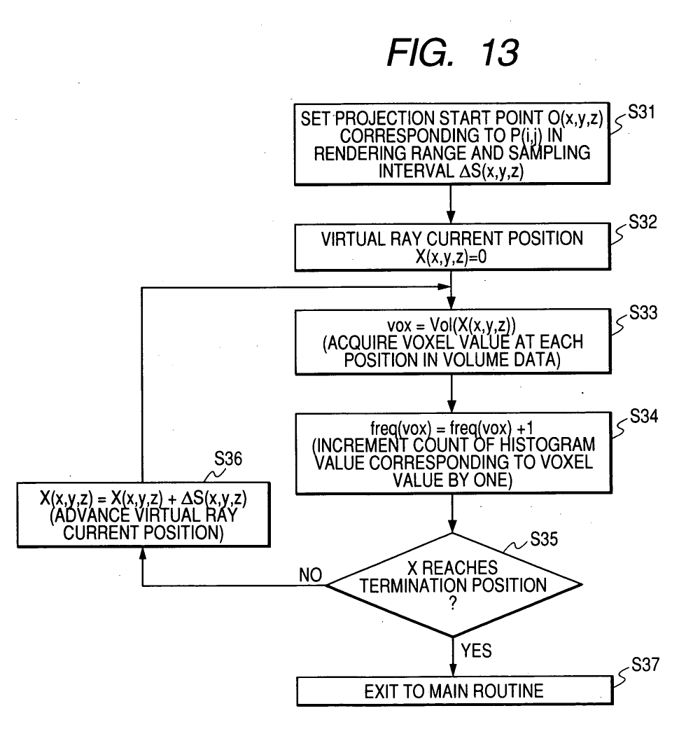

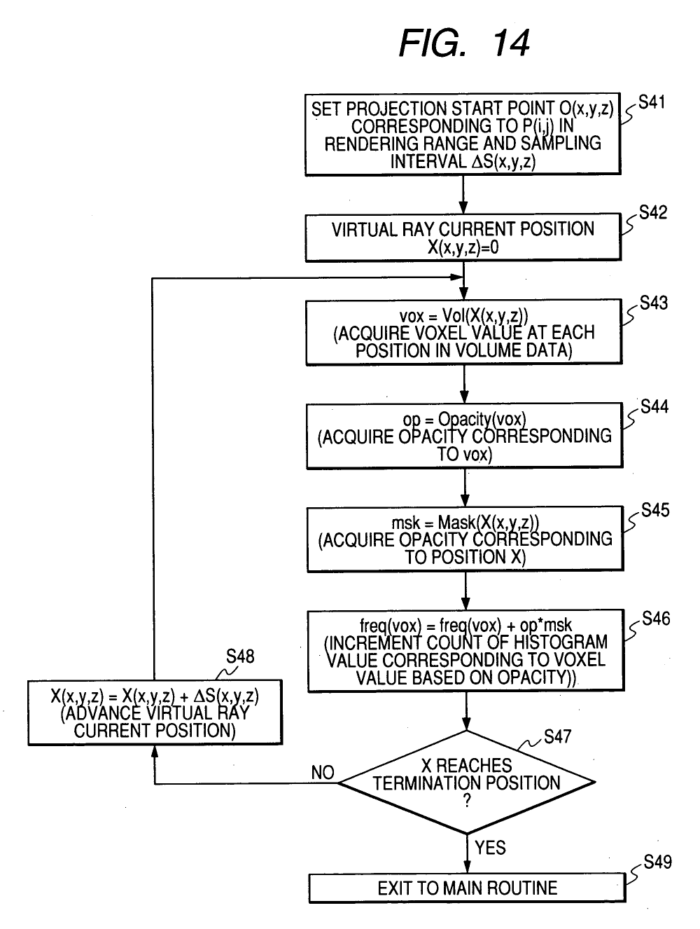

Next, i=i+1 is calculated (step S20), and the process returns to step S18. At step S18, if i<x_max is false (No), j=j+1 is calculated (step S21), and the process returns to step S16. At step S16, if j<y_max is false (No), the process is terminated (step S22). Step 19 is described in detail with reference to FIGS. 13 and 14.

FIG. 13 shows details of the processing obtaining a histogram based on a virtual ray. FIG. 13 is a detailed flowchart of step S19 in FIG. 12. In this case, a projection start point O(x,y,z) corresponding to P(i,j) in the rendering range and a sampling interval ΔS(x,y,z) are set (step S31). Then, a virtual ray current position X (x,y,z)=0 is set (step S32).

Next, the voxel value at current position in the volume data is acquired according to vox=Vol (X (x,y,z)) (step S33). Next, a count of the histogram value corresponding to the voxel value is incremented by one according to freq (vox)=freq(vox)+1 (step S34).

Next, whether or not X reaches a termination position is determined (step S35). If X is not at the termination position (No at step S35), the virtual ray current position is advanced according to X(x,y,z)=X(x,y,z)+ΔS(x,y,z) (step S36), and the process returns to step S33. On the other hand, in step S35, if X reaches the termination position (Yes), the process exits to the main routine (step S19 in FIG. 12) (step S37).

FIG. 14 shows details of the processing obtaining a histogram based on a virtual ray, further considering a mask region and opacity of an opacity function. FIG. 14 is also a detailed flowchart of step S19 in FIG. 12. In this case, a projection start point O(x,y,z) corresponding to P (i,j) in the rendering range and sampling interval ΔS(x,y,z) are set (step S41), and a virtual ray current position X(x,y,z)=0 is set (step S42).

Next, the voxel value at current position in the volume data is acquired according to vox=Vol (X(x,y,z)) (step S43), and the opacity corresponding to vox is acquired according to op=Opacity (vox) (step S44). The opacity corresponding to the position X is acquired according to msk=Mask(X(x,y,z)) (step S45).

Next, a count of the histogram value corresponding to the voxel value is incremented based on the opacity according to freq (vox)=freq(vox)+op*msk (step S46), and whether or not X reaches the termination position is determined (step S47) If X is not at the termination position (No at step S47), the virtual ray current position is advanced according to X(x,y,z)=X(x,y,z)+ΔS(x,y,z) (step S48), and the process returns to step S43. On the other hand, in step S47, if X reaches the termination position (Yes), the process exits to the main routine (step S19 in FIG. 12) (step S49).

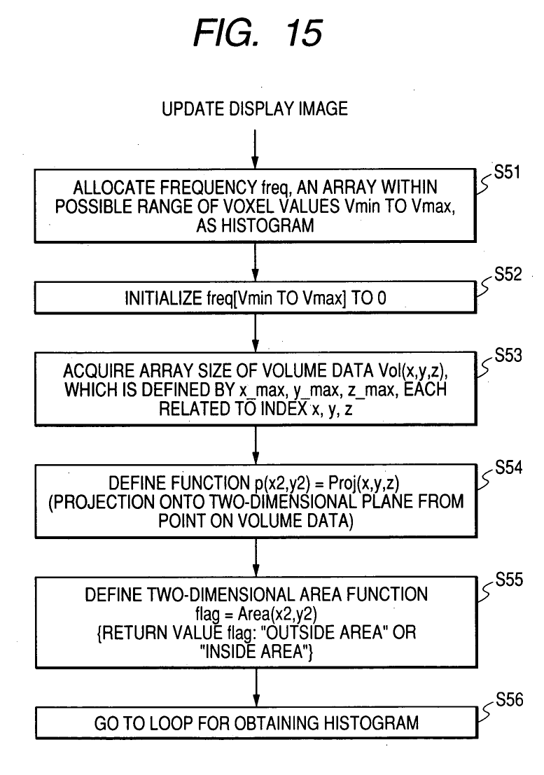

FIG. 15 is a flowchart showing an outline of processing obtaining a histogram by executing a region projection. In this case, when the display image is updated by an operation of the user such as a doctor, a frequency freq, which is an array within a possible range of voxel values from Vmin to Vmax, is allocated as a histogram(step S51).

Next, the frequency freq[Vmin to Vmax] is initialized to 0 (step S52), and an array size of volume data Vol (x,y,z), which is defined by x_max, y_max, z_max, each related to index x, y, z, is acquired (step S53).

Next, a function p (x2,y2)=Proj(x,y,z) is defined in which projection onto a two-dimensional plane from a point on the volume data is performed (step S54). For example, in case of the parallel projection, the function can be defined as p (x2,y2)=A(projection matrix) (x,y,z)+B(offset).

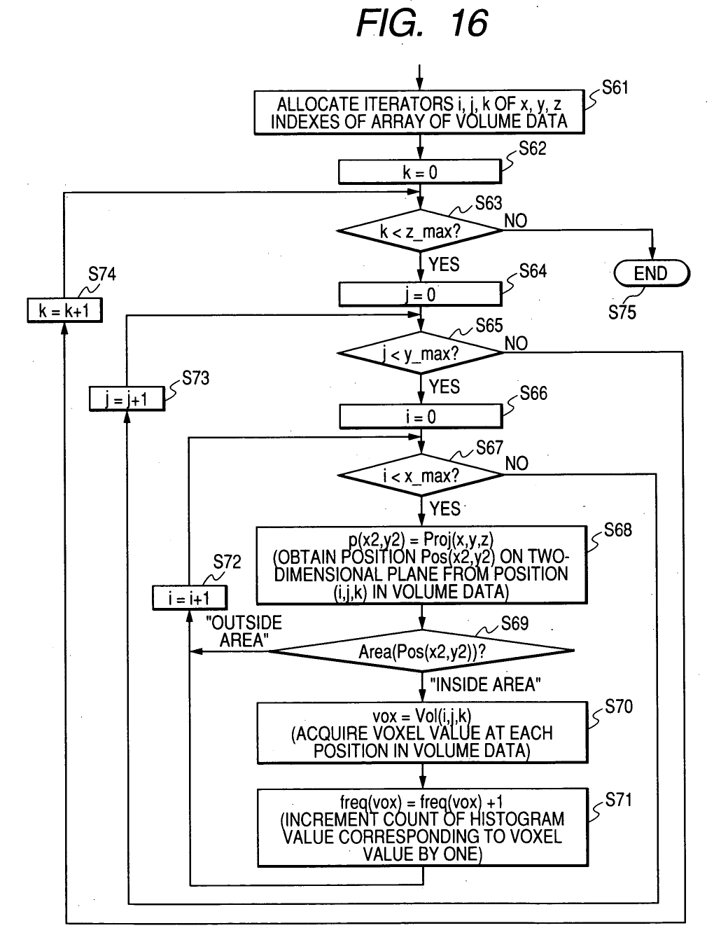

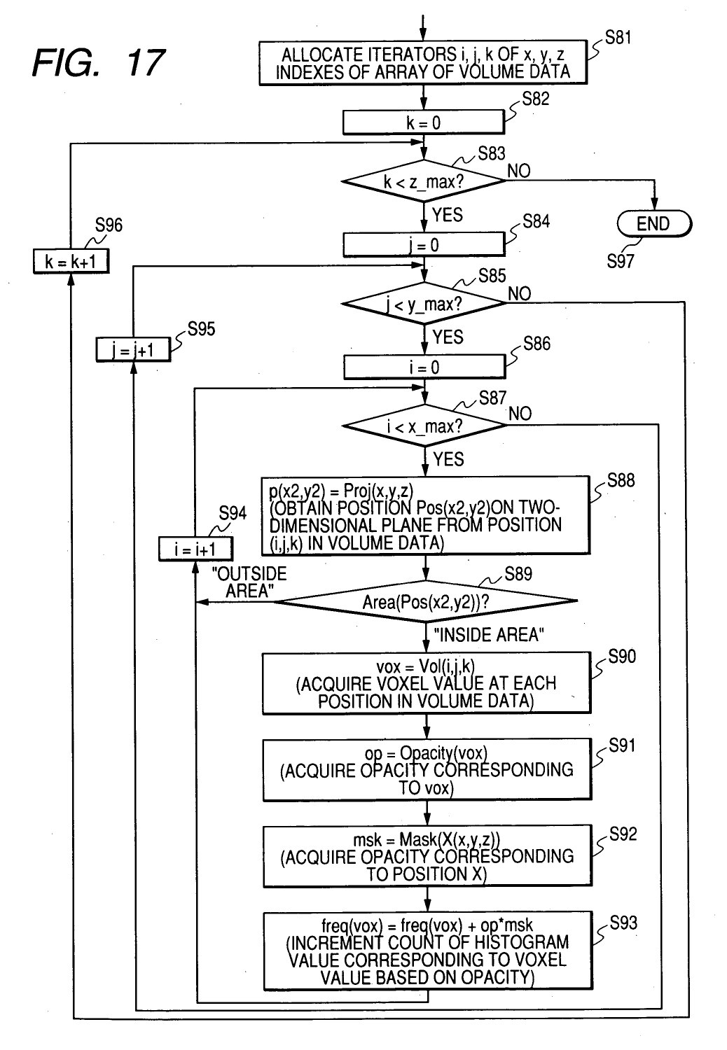

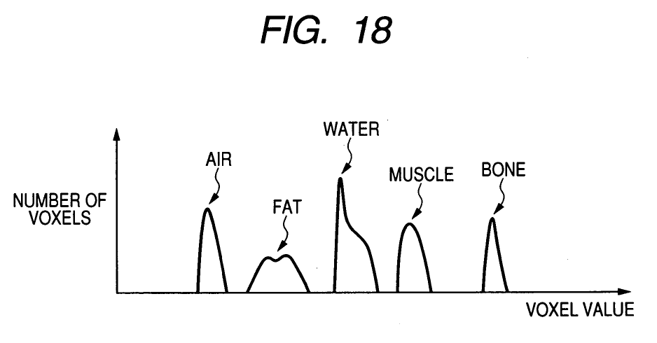

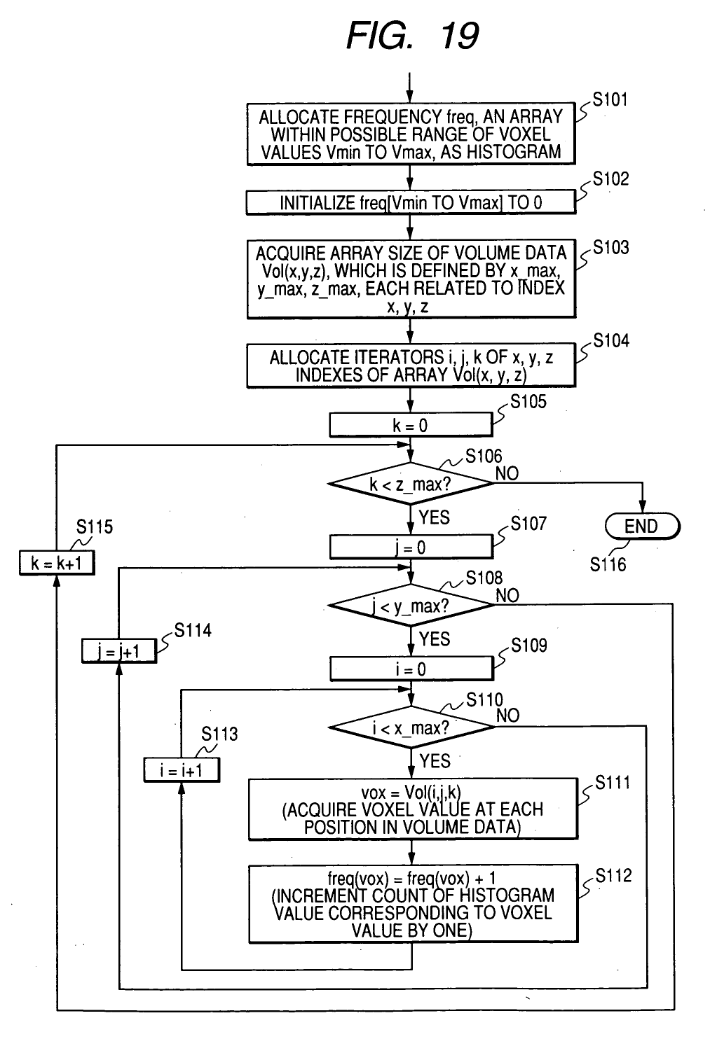

Next, a two-dimensional area function flag=Area(x2,y2) {return value flag is “outside area” or “inside area”} is defined (step S55). For example, when the area is a rectangle Rect(left, right, top, bottom), the function can be defined as follows: If an expression “left<=x2 and x2<right and top<=y2 and y2<bottom” is true, “inside area” is returned; if the expression is false, “outside area” is returned. Next, the process executes a loop for obtaining a histogram (step S56), which is described in detail with reference to FIGS. 16 and 17.

FIG. 16 is a flowchart showing a loop for obtaining a histogram in the processing obtaining a histogram by executing a region projection. In this case, iterators i, j, k of the x, y, z indexes of the array of the volume data are allocated (step S61). As a start of a triple loop for scanning the volume, k=0 is set (step S62).

Next, whether or not k<z_max is determined (step S63). If k<z_max (Yes at step S63), j=0 is set (step S64) and whether or not j<y_max is determined (step S65). If j<y_max (Yes at step S65), i=0 is set (step S66) and whether or not i<x_max is determined (step S67).

If i<x_max (Yes at step S67), a position on a two-dimensional plane, Pos (x2, y2), is obtained from the position (i,j,k) in volume data, according to the function p(x2, y2)=Proj(x,y,z) (step S68). Whether or not Area(Pos(x2,y2)) is inside the area is determined (step S69). If Area(Pos(x2,y2)) is inside the area, the voxel value at current position in the volume data is acquired according to vox=Vol(i,j,k) (step S70).

Next, a count of the histogram value corresponding to the voxel value is incremented by one according to freq(vox)=freq(vox)+1 (step S71) .Then, i=i+1 is calculated (step S72), and the process returns to step S67. On the other hand, if it is determined at step S69 that Area(Pos(x2,y2)) is outside the area, i=i+1 is also calculated (step S72), and the process returns to step S67.

Next, at step S67, if i<x_max is false (No), j=j+1 is calculated (step S73) and the process returns to step S65. At step S65, if j<y_max is false (No), k=k+1 is calculated (step S74) and the process returns to step S63. At step S63, if k<z_max is false (No), the process is terminated (step S75).

FIG. 17 is a flowchart showing a loop for obtaining a histogram in the processing obtaining a histogram by executing a region projection, further considering a mask region and opacity of an opacity function. In this case, iterators i, j, k of the x, y, z indexes of an array of the volume data are allocated (step S81) . As a start of a triple loop for scanning the volume, k=0 is set (step S82).

Next, whether or not k<z_max is determined (step S83). If k<z_max (Yes at step S83), j=0 is set (step S84) and whether or not j<y_max is determined (step S85) . If j<y_max (Yes at step S85), i=0 is set (step S86) and whether or not i<x_max is determined (step S87).

If i<x_max (Yes at step S87), a position on a two-dimensional plane, Pos (x2, y2), is obtained from the position (i, j, k) in volume data, according to the function p(x2,y2)=Proj(x,y,z) (step S88). Then, whether or not Area(Pos(x2,y2)) is inside the area is determined (step S89)

If Area(Pos(x2,y2)) is inside the area, the voxel value at current position in the volume data is acquired according to vox=Vol(i,j,k) (step S90). Then, opacity corresponding to vox is acquired according to op=Opacity(vox) (step S91). Then, opacity corresponding to the position X is acquired according to msk=Mask(X(x,y,z)) (step S92).

Next, a count of the histogram value corresponding to the voxel value is incremented based on the opacity according to freq(vox)=freq(vox)+op*msk (step S93). Then, i=i+1 is calculated (step S94), and the process returns to step S87. On the other hand, if it is determined at step S89 that Area(Pos(x2,y2)) is outside the area, i=i+1 is also calculated (step S94), and the process returns to step S87.

Next, at step S87, if i<x_max is false (No), j=j+1 is calculated (step S95), and the process returns to step S85. At step S85, if j<y_max is false (No), k=k+1 is calculated (step S96), and the process returns to step S83. At step S83, if k<z_max is false (No), the process is terminated (step S97).

According to the image processing method of above described embodiments, when a medical diagnosis using image display and histogram display is conducted, an appropriate histogram can be displayed in response to the intention of the user such as a doctor. Moreover, since a change of the three-dimensional region is reflected on the histogram interactively, the method can also be used as an aid of an operation specifying the region. Moreover, the user can also specify a region not displayed on the image as the three-dimensional region, information unavailable from the image can be shown to the user. Further, in the histogram of the rendering region, information of the object hidden behind in the image is available.

According to the image processing method and the computer readable medium for image processing of the invention, an appropriate histogram can be displayed in response to the intention of the user, when conducting a medical diagnosis based on image display and histogram display.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An image processing method based on volume rendering, said image processing method comprising:
generating a two-dimensional image by the volume rendering using first volume data;
setting a two-dimensional area in the two-dimensional image;
determining a first voxel group which is included in said first volume data, said first group corresponding to the two-dimensional area being set; and
generating a first histogram of the first voxel group to be dynamically changed by the two-dimensional area being set.

2. An image processing method based on volume rendering, said image processing method comprising:
generating a two-dimensional image by the volume rendering using first volume data;
setting a two-dimensional area in the two-dimensional image;
determining a first three-dimensional region represented by the first volume data, said first three-dimensional region corresponding to the two-dimensional area being set;
determining a voxel group which is included in second volume data, said voxel group corresponding to the first three-dimensional region; and
generating a histogram of the voxel group to be dynamically changed by the two-dimensional area being set.

3. The image processing method as claimed in claim 1, further comprising:
determining a first three-dimensional region represented by the first volume data, said first three-dimensional region corresponding to the two-dimensional area being set;
determining a second voxel group which is included in second volume data, said second voxel group corresponding to the first three-dimensional region; and
generating a second histogram of the second voxel group to be dynamically changed by the two-dimensional area being set.

4. The image processing method as claimed in claim 1, wherein the first voxel group is further included in a three-dimensional mask region.

5. The image processing method as claimed in claim 1, wherein the first histogram is generated by multiplying a weight factor corresponding to opacity of each voxel in the first voxel group.

6. The image processing method as claimed in claim 1, wherein a plurality of said first histograms are generated based on a plurality of the first voxel groups respectively.

7. The image processing method as claimed in claim 1, wherein the volume rendering is performed based on a parallel projection.

8. The image processing method as claimed in claim 1, wherein the volume rendering is performed based on a perspective projection.

9. The image processing method as claimed in claim 1, wherein the volume rendering is performed based on a cylindrical projection.

10. The image processing method as claimed in claim 2, wherein said voxel group is further included in a three-dimensional mask region.

11. The image processing method as claimed in claim 2, wherein the histogram is generated by multiplying a weight factor corresponding to opacity of each voxel in the voxel group.

12. The image processing method as claimed in claim 2, wherein a plurality of said histograms are generated based on a plurality of the voxel groups respectively.

13. The image processing method as claimed in claim 2, wherein the volume rendering is performed based on a parallel projection.

14. The image processing method as claimed in claim 2, wherein the volume rendering is performed based on a perspective projection.

15. The image processing method as claimed in claim 2, wherein the volume rendering is performed based on a cylindrical projection.

16. A computer readable medium having a program including instructions for permitting a computer to perform image processing based on volume rendering, said instructions comprising:
generating a two-dimensional image by the volume rendering using volume data;
setting a two-dimensional area in the two-dimensional image;
determining a voxel group which is included in the volume data, said voxel group corresponding to the two-dimensional area being set; and
generating a histogram of the voxel group to be dynamically changed by the two-dimensional area being set.
